(19) United States
(12) Patent Application Publication
(10) Pub. No.: US 2015/0130774 A1
(43) Pub. Date: May 14, 2015

(54) Switch for Activating a Data Protection Mode for an Electronic Appliance

(71) Applicant: Thorsten Krüger, Warngau (DE)

(72) Inventor: Thorsten Krüger, Warngau (DE)

(21) Appl. No.: 14/539,099

(22) Filed: Nov. 12, 2014

(30) Foreign Application Priority Data
Nov. 13, 2013 (EP) 13192708

(51) Int. Cl. G06F 21/60; G06F 21/62; G06F 3/02

(52) U.S. Cl. CPC G06F 21/60; G06F 3/0227; G06F 21/6245
USPC 345/184

(57) ABSTRACT

A switch activates a data protection mode for an electronic appliance configured to send data stored on the electronic appliance. The switch has an interface for coupling the switch to the electronic appliance. The switch is configured to send a signal to the electronic appliance upon mechanical operation by a user to activate the data protection mode. The switch may be used to activate the data protection mode to deactivate the transmission of personal data.

This application claims the benefit of EP 13192708.9, filed on Nov. 13, 2013, which is hereby incorporated by reference in its entirety.

### FIELD

The disclosed embodiments relate to activating a data protection mode for an electronic appliance.

### BACKGROUND

Many electronic appliances, such as mobile terminals, which also include smart phones or tablet personal computers (PCs), are used to store data that may be regarded as personal data. By way of example, personal or private data of this kind includes location-related and time-related data that permits inferences as to the whereabouts of a user of the electronic appliance. Furthermore, personal data of this kind also includes sensor data that is collected or produced by the electronic appliance and sent to various service providers, including the network operator. It is not always desirable for such data to be visible, e.g., capable of being seen by third parties, or to be sent to third parties, such as service providers or the network operator.

Existing electronic appliances allow settings to be selected to limit the sending of personal data of this kind. However, it is not always transparent which data is sent by the electronic appliance. Such settings are frequently selected by the user in an awkward manner using the appliance software, as the settings are not obvious to the user.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, the disclosed embodiments may provide an apparatus for controlling transmission (e.g., sending) of personal data.

Accordingly, a switch for activating a data protection mode for an electronic appliance is described. The electronic appliance is configured to send data stored on the electronic appliance. The switch has an interface for coupling the switch to the electronic appliance. The switch is configured to send a signal to the electronic appliance upon mechanical operation by a user to activate the data protection mode.

The coupling produced by the interface may be electronic coupling. The electronic coupling allows a signal to be transmitted between the switch and the electronic appliance. The signal sent to the electronic appliance activates a data protection mode. The activation of the data protection mode changes settings on the electronic appliance for sending stored data.

The switch, which is a mechanical switch or hardware switch, allows activation of a data protection mode in a straightforward manner. In this context, data protection mode relates to a mode in which forwarding of data, for example to the network operator or another third-party provider, is restricted. Because the data protection mode is effected using a mechanical switch, the activation of the data protection mode is a straightforward matter even for an inexperienced user. The user may not be acquainted with the settings menu on the electronic appliance, but nonetheless be capable of activating the data protection mode via operation of a switch, as in switching on/off the sound of a smart phone.

According to one embodiment, the interface is a radio interface.

In some examples, the radio interface may be a Bluetooth interface. Therefore, the switch may not be physically connected to the electronic appliance, but rather may communicate solely via the radio interface. In this way, the switch may also be arranged remotely from the electronic appliance. By way of example, the switch may be mounted on a keyboard and activate a data protection mode for a desktop computer to which the keyboard is connected.

According to one embodiment, the interface is a wired interface.

In some examples, the switch may be physically coupled to the electronic appliance via any port on the electronic appliance, such as a headphone or charging cable port. The interface is thus a plug-in interface. The connection may also be established via a USB port. Alternatively, the switch may be incorporated or implemented in the electronic appliance directly.

According to one embodiment, the stored data includes personal data from the user.

In some examples, the personal data or private data may be sensor data collected or produced by the electronic appliance and sent to third parties. Furthermore, the personal data may also be location-related and time-related data. By way of example, the data may also include microphone/camera or voice and image data. Furthermore, the stored data may also be acceleration data.

In one embodiment, the user may identify stored data as personal data. This identification allows precise definition of the data permitted to be forwarded by the electronic appliance in the data protection mode and the data not permitted to be forwarded.

According to one embodiment, the switch is configured to deactivate the data protection mode in response to initial (e.g., fresh) operation from the user.

Therefore, the switch is operable to activate and deactivate the data protection mode. The activation and deactivation may be effected via operation of the switch. By way of example, the switch may be configured as a sliding switch or a momentary-contact switch.

According to one embodiment, the electronic appliance is configured to send no stored data in the activated data protection mode.

According to one embodiment, no types of stored data are sent in the activated data protection mode. The data protection mode or privacy mode does not restrict the normal communication of the electronic appliance with other appliances. However, the transmission (e.g., sending) of stored data is blocked.

According to one embodiment, the switch has a first switch position and a second switch position. The first switch position corresponds to a deactivated data protection mode and the second switch position corresponds to an activated data protection mode.

According to one embodiment, the mode that the appliance is indicated by the position of the switch. By way of example, the first switch position may be identified in color and the second switch position may be identified without any color or with a different color marking. A further way of identifying switch positions involves providing indicator elements. By way of example, light emitting diodes (LEDs) may be provided that shine in different colors or are switched on or off, depending on the setting of the switch.

According to one embodiment, the switch has a third switch position, which corresponds to a restricted data protection mode.

In the restricted data protection mode, some of the stored data may be sent and some of the stored data may not be sent. The third switch position may also be referred to as an intermediate switch position.

According to one embodiment, the electronic appliance is configured to not send predefined stored data in the restricted data protection mode.

The stored data not to be sent in the restricted data protection mode may be predefined by a user. The restricted data protection mode therefore is operable as a filter. By way of example, the type of connection that may be used to send data may be defined. Furthermore, the type of data that may be sent may also be defined. By way of example, location-relevant and time-relevant data may be defined as capable of being sent, while voice and image data may be defined as not capable of being sent. Any other type or combination of definitions may likewise be selected.

According to one embodiment, the switch is configured to activate a control device of the electronic appliance to process settings for the data protection mode.

By way of example, the control device may display a control center from the electronic appliance on a display of the electronic appliance to allow the user to select settings. Settings may be selected for the restricted data protection mode to define the predefined stored data. The control device forwards the position of the switch internally in the electronic appliance to other software components. These software components are then configured appropriately to implement the data protection mode.

By way of example, initial operation of the switch may be used to activate the control device. Alternatively, a certain phase (e.g., period) of operation of the switch may be used to activate the control device.

According to one embodiment, the data protection mode influences a visibility of the electronic appliance to other electronic appliances.

In this way, the data protection mode may be configured such that the electronic appliance is invisible to third parties, and hence is not configured to receive data. Normal communication, such as access to a network, may not necessarily be restricted, but rather only the visibility to third parties.

According to one aspect, an electronic appliance includes a switch with the features described above and an interface. The interface is configured to couple the electronic appliance to the switch.

According to one embodiment, the switch is integrated in the electronic appliance.

By way of example, the switch may protrude from the electronic appliance as a mechanical switch for operation by a user. In this case, the interface of the switch and the interface of the electronic appliance are internal interfaces within the electronic appliance.

According to one embodiment, the electronic appliance has a memory device for storing personal data.

The activation of the data protection mode allows the forwarding of data stored in the memory device to be restricted.

According to one aspect, a method activates a data protection mode for an electronic appliance configured to send data stored on the electronic appliance. The method includes coupling of the switch to the electronic appliance via an interface. Mechanical operation of the switch by a user occurs. In response to the mechanical operation, the transmission (e.g., sending) of a signal to the electronic appliance is implemented and the data protection mode is activated.

In one aspect, a computer program product prompts the performance of the method as described above on a programmable device.

By way of example, a computer program product may be provided or delivered as a storage medium, such as a memory card, USB stick, CD-ROM, DVD, or a stored file downloaded from a server in a network. The downloading may be implemented via a wireless communication network, for example, via the transmission of an appropriate file including the computer program product of a non-transitory computer readable storage medium.

The embodiments and features described for the proposed sensor and the electronic appliance apply to the proposed method accordingly.

Further possible implementations of the invention include combinations not expressly characterized as features or embodiments described above or below for the exemplary embodiments. In this case, a person skilled in the art may also add individual aspects as improvements or enhancements of the respective basic form of the invention.

### BRIEF DESCRIPTION OF THE DRAWINGS

FIG. 1 shows a schematic view of an exemplary embodiment of a switch with an electronic appliance.

FIG. 2 shows a schematic view of an exemplary embodiment of an electronic appliance.

FIG. 3 shows a schematic view of an exemplary embodiment of a control center for the electronic appliance of FIG. 2.

FIG. 4 shows a schematic view of an exemplary embodiment of an electronic appliance.

FIG. 5 shows an exemplary embodiment of a method for activating a data protection mode.

### DETAILED DESCRIPTION

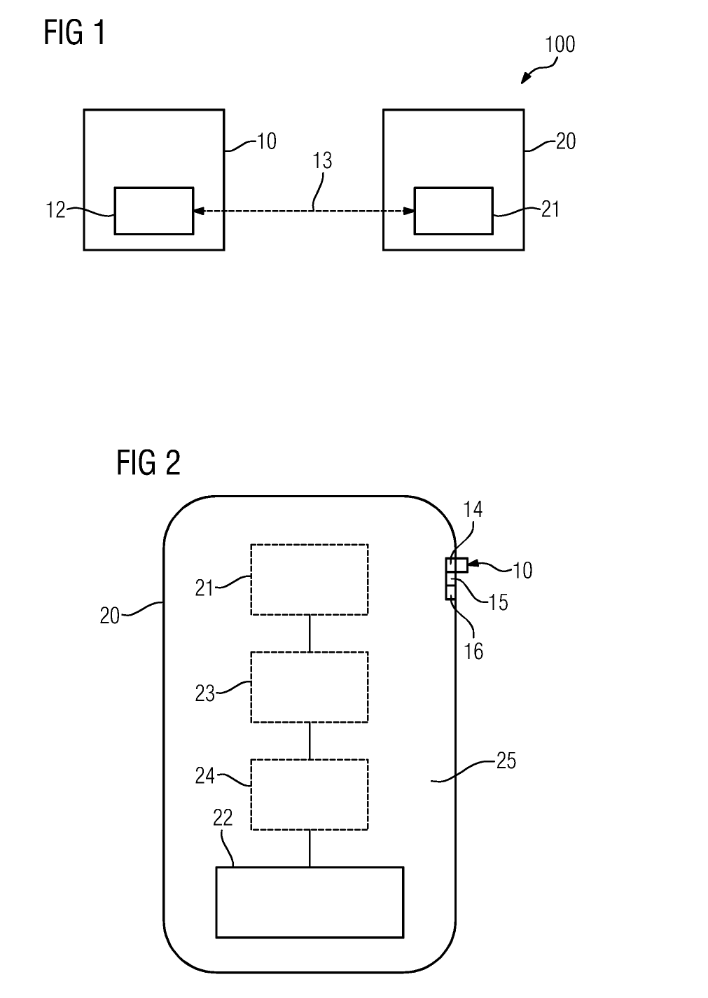

FIG. 1 shows a system 100 in which a switch 10 may select settings for personal data on an electronic appliance 20. The switch 10 has an interface 12 that may be coupled to a corresponding interface 21 of the electronic appliance 20. The switch 10 may use this interface 12 to send signals 13 to the interface 21 of the electronic appliance 20. This communication may be realized either in wired fashion via a physical interface or wirelessly via a radio interface.

When the switch 10 is operated by a user, the switch 10 sends a signal 13 to the electronic appliance 20. The electronic appliance 20 receives the signal 13 via the interface 21. Based on the mechanical operation of the switch 10 or in response to the signal 13, the electronic appliance 20 activates or deactivates a data protection mode. In the case of an activated data protection mode, data stored on the electronic appliance 20 identified as personal data are not sent to third parties. In the case of a deactivated data protection mode, the personal data are sent to third parties.

FIG. 2 shows an example of an electronic appliance 20 in the form of a smart phone or tablet PC. The switch 10 is physically integrated in the appliance 20 of FIG. 2, and is configured as a switch 10 on an outer side of the electronic appliance 20.

The switch 10 has three stages 14, 15, 16. In a switched-on stage 14, the transmission (e.g., sending) of all personal data is deactivated. In the switched-off stage 16, the transmission of all personal data is activated. In an intermediate position 15, the transmission of personal data is activated or deactivated to a restricted degree.

The intermediate position 15 may be selected via a control center 22 presented on a screen or display 25 of the electronic appliance 20. The control center 22 is called by a control device 24 in response to operation of the switch 10. The user may use the control center 22 or the control device 24 to establish (e.g., set) which data may be regarded as personal data and/or which personal data may be sent to third parties in the intermediate position 15. The personal data is stored in a memory device 23 of the electronic appliance 20.

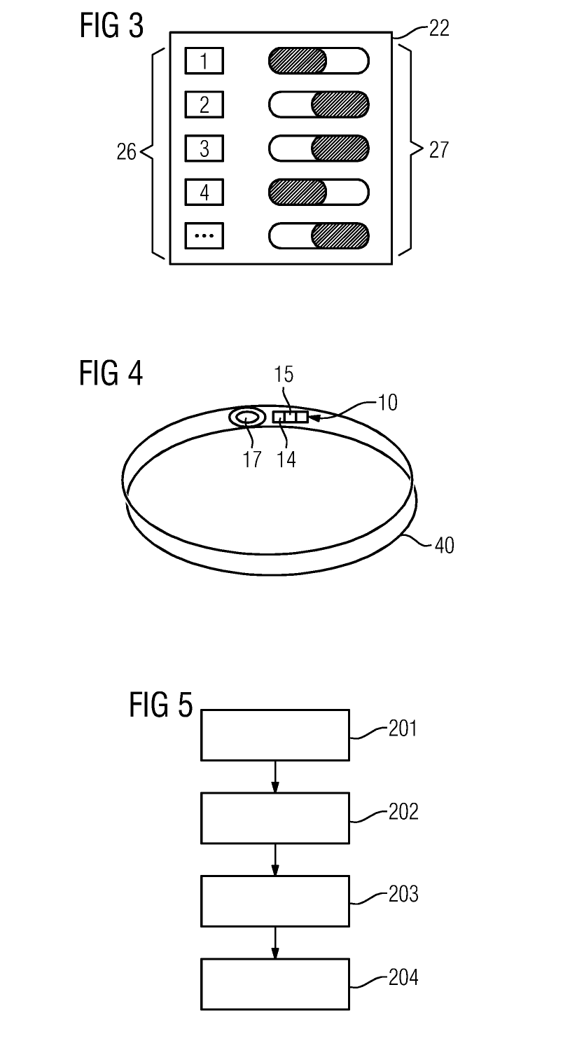

FIG. 3 shows an exemplary control center 22. As soon as the user opens the control center 22, various setting options 1, 2, 3, 4, . . . indicated at 24 are provided. The setting options 24 may be various types of personal data. By way of example, these include location-dependent data, time-dependent data, acceleration data, microphone/camera data or voice and image data. Each type of data may be activated or deactivated using a sliding switch 27.

FIG. 4 shows a further example of a system with a switch 10. In this case, the system is a sensor band 40 having a sensor 17. By way of example, the sensor band 40 may be realized as a pulse meter. In this case, the sensor 17 transmits the pulse data to a remote appliance (not shown). The switch 10 may limit the transfer of the pulse data from the sensor 17 to a remote electronic appliance.

FIG. 5 shows an exemplary embodiment of a corresponding method. The method involves an act 201 to couple the switch 10 to the electronic appliance 20 via an interface 12, 21. In act 202, the switch 10 is mechanically operated by a user. In response to the mechanical operation, a signal 13 is sent to the electronic appliance 20 in act 203. The transmission (e.g., sending) of the signal 13 or the reception of the signal 13 in the electronic appliance 20 activates the data protection mode in act 204.

One or more of the acts, elements, system components, or other aspects of the disclosed embodiments described above may be implemented by a processor of the electronic appliance 20. A non-transitory memory of the electronic appliance 20 stores instructions for configuring the processor to implement the method act(s).

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1. A switch for activating a data protection mode for an electronic appliance, the electronic appliance being configured to send data stored on the electronic appliance, the electronic appliance comprising:
an interface to couple the switch to the electronic appliance,
wherein the switch is configured to send a signal to the electronic appliance upon mechanical operation by a user to activate the data protection mode.

2. The switch of claim 1, wherein the interface is a radio interface.

3. The switch of claim 1, wherein the interface is a wired interface.

4. The switch of claim 1, wherein the stored data includes personal data from the user.

5. The switch of claim 1, wherein the switch is configured to deactivate the data protection mode in response to initial operation from the user.

6. The switch of claim 1, wherein the electronic appliance is configured to send no stored data in the data protection mode.

7. The switch of claim 1, wherein a first switch position of the switch corresponds with a deactivated data protection mode, and wherein a second switch position of the switch corresponds with an activated data protection mode.

8. The switch of claim 7, wherein a third switch position of the switch corresponds with a restricted data protection mode.

9. The switch of claim 8, wherein the electronic appliance is configured not to send predefined stored data in the restricted data protection mode.

10. The switch of claim 1, wherein the switch is configured to activate a control device of the electronic appliance to process settings for the data protection mode.

11. The switch of claim 1, wherein the data protection mode influences a visibility of the electronic appliance to other electronic appliances.

12. An electronic appliance comprising:
a switch to activate a data protection mode for the electronic appliance; and
an interface configured to couple the electronic appliance to the switch,
wherein the electronic appliance is configured to send data stored on the electronic appliance, and
wherein the switch is configured to send a signal to the electronic appliance upon mechanical operation by a user to activate the data protection mode.

13. The electronic appliance of claim 12, wherein the switch is integrated in the electronic appliance.

14. The electronic appliance of claim 12, further comprising a memory device configured to store personal data.

15. A method for activating a data protection mode for an electronic appliance, the electronic appliance being configured to send data stored on the electronic appliance, the method comprising:
coupling the switch to the electronic appliance via an interface;
sending a signal to the electronic appliance in response to mechanical operation of the switch by a user; and
activating the data protection mode in response to the signal.

16. The method of claim 15, further comprising activating a control device of the electronic appliance to process settings for the data protection mode.

17. The method of claim 15, wherein the data protection mode influences a visibility of the electronic appliance to other electronic appliances.

18. The electronic appliance of claim 12, wherein:
a first switch position of the switch corresponds with a deactivated data protection mode;
a second switch position of the switch corresponds with an activated data protection mode;
a third switch position of the switch corresponds with a restricted data protection mode; and
the electronic appliance is configured not to send predefined stored data in the restricted data protection mode.

19. The electronic appliance of claim 18, wherein the switch is configured to activate a control device of the electronic appliance to process settings for the data protection mode.

20. The electronic appliance of claim 12, wherein the data protection mode influences a visibility of the electronic appliance to other electronic appliances.
